(19) United States
(12) Patent Application Publication
(10) Pub. No.: US 2025/0028082 A1
(43) Pub. Date: Jan. 23, 2025

(54) Optical Systems with Gratings and Anti-reflective Layers

(71) Applicant: Apple Inc., Cupertino, CA (US)

(72) Inventors: Jian Gao, Fremont, CA (US); Francesco Aieta, Alameda, CA (US); Jaebum Chung, Mountain View, CA (US); Ligang Wang, San Jose, CA (US); Se Baek Oh, Hillsborough, CA (US); Brandon Born, Sunnyvale, CA (US)

(21) Appl. No.: 18/904,959

(22) Filed: Oct. 2, 2024

Related U.S. Application Data
(63) Continuation of application No. PCT/US23/65572, filed on Apr. 10, 2023.
(60) Provisional application No. 63/340,285, filed on May 10, 2022.

(51) Int. Cl. G02B 1/11; F21V 8/00; G02B 5/18; G02B 27/01

(52) U.S. Cl. CPC G02B 1/11; G02B 5/1814; G02B 5/1842; G02B 6/0016; G02B 6/0038; G02B 27/0172; G02B 2027/0174; G02B 2027/0178

(57) ABSTRACT

A display system may include a waveguide and at least one surface relief grating (SRG) structure. The SRG structure may include a plurality of ridges separated by a plurality of troughs. The SRG structure may include an anti-reflective layer to mitigate specular reflections off of the ridges. The anti-reflective layer may be formed above the ridges such that the ridges are interposed between the waveguide and the anti-reflective layer. In this type of arrangement, the anti-reflective layer may fill the troughs between the ridges or may be patterned to overlap the ridges without filing the troughs. The anti-reflective layer may be formed below the ridges such that the anti-reflective layer is interposed between the ridges and the waveguide. The SRG structure may include multiple anti-reflective layers. When multiple anti-reflective layers are included, the anti-reflective layers may have at least one differing property (e.g., material, number of layers, dimension).

This application is a continuation of international patent application No. PCT/US2023/065572, filed Apr. 10, 2023, which claims priority to U.S. provisional patent application No. 63/340,285, filed May 10, 2022, which are hereby incorporated by reference herein in their entireties.

### BACKGROUND

This disclosure relates generally to optical systems and, more particularly, to optical systems for electronic devices with displays.

Electronic devices often include displays that present images close to a user's eyes. For example, virtual and augmented reality headsets may include displays with optical elements that allow users to view the displays.

Devices such as these can be challenging to design. If care is not taken, the components used to display images in these devices can be unsightly and bulky and may not exhibit a desired optical performance.

### SUMMARY

An electronic device may have a display system. The display system may include a waveguide and at least one surface relief grating (SRG) structure. The SRG structure may include a plurality of ridges separated by a plurality of troughs.

The SRG structure may include an anti-reflective layer to mitigate specular reflections off of the SRG surface due to its high refractive indices. The anti-reflective layer may be formed above the ridges such that the ridges are interposed between the waveguide and the anti-reflective layer. In this type of arrangement, the anti-reflective layer may fill the troughs between the ridges or may be patterned to overlap the ridges without filing the troughs. The anti-reflective layer may be formed below the ridges such that the anti-reflective layer is interposed between the ridges and the waveguide.

The SRG structure may include multiple anti-reflective layers. One anti-reflective layer may be above the ridges while another anti-reflective layer may be below the ridges. Alternatively, one anti-reflective layer may be aligned with a first subset of the ridges while another anti-reflective layer may be aligned with a second subset of the ridges. When multiple anti-reflective layers are included, the anti-reflective layers may have at least one differing property (e.g., material, number of layers, dimension).

### BRIEF DESCRIPTION OF THE DRAWINGS

FIG. 1 is a diagram of an illustrative system having a display in accordance with some embodiments.

FIG. 2 is a top view of an illustrative optical system for a display having a waveguide with optical couplers in accordance with some embodiments.

FIGS. 3A-3C are top views of illustrative waveguides provided with a surface relief grating structure in accordance with some embodiments.

FIG. 4 is a cross-sectional side view of an illustrative surface relief grating structure with an anti-reflective layer formed over ridges in accordance with some embodiments.

FIG. 5 is a cross-sectional side view of an illustrative surface relief grating structure with an anti-reflective layer that is patterned over the ridges without filling troughs between the ridges in accordance with some embodiments.

FIG. 6 is a cross-sectional side view of an illustrative surface relief grating structure with ridges defined by an anti-reflective layer in accordance with some embodiments.

FIG. 7 is a cross-sectional side view of an illustrative surface relief grating structure with an anti-reflective layer formed below ridges in accordance with some embodiments.

FIG. 8 is a cross-sectional side view of an illustrative surface relief grating structure with a first anti-reflective layer formed below ridges and a second anti-reflective layer patterned above ridges in accordance with some embodiments.

FIG. 9 is a cross-sectional side view of an illustrative surface relief grating structure with a first anti-reflective layer formed below ridges and a second anti-reflective layer formed above ridges in accordance with some embodiments.

FIG. 10 is a cross-sectional side view of an illustrative surface relief grating structure with a first anti-reflective layer formed above a first subset of ridges and a second anti-reflective layer formed above a second subset of ridges in accordance with some embodiments.

FIG. 11 is a cross-sectional side view of an illustrative surface relief grating structure with an anti-reflective layer and an encapsulation layer in accordance with some embodiments.

FIG. 12 is a cross-sectional side view of an illustrative surface relief grating structure with an anti-reflective layer on sloped ridges in accordance with some embodiments.

FIG. 13 is a cross-sectional side view of an illustrative method of forming an encapsulation layer over ridges in a surface relief grating structure in accordance with some embodiments.

### DETAILED DESCRIPTION

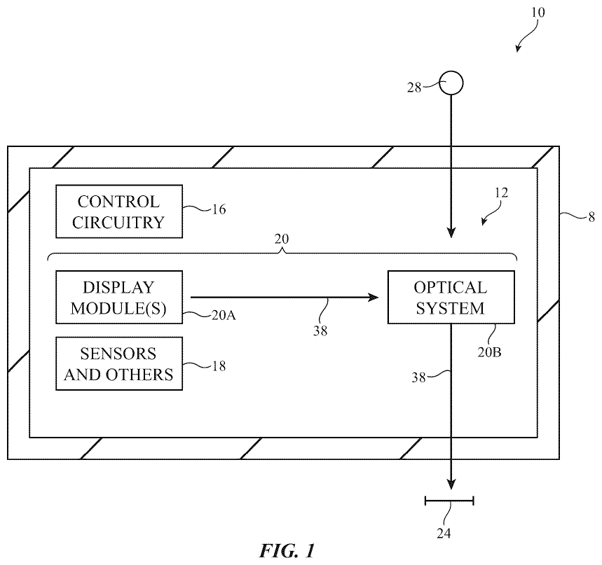

System 10 of FIG. 1 may be a head-mounted device having one or more displays. The displays in system 10 may include near-eye displays 20 mounted within support structure (housing) 8. Support structure 8 may have the shape of a pair of eyeglasses or goggles (e.g., supporting frames), may form a housing having a helmet shape, or may have other configurations to help in mounting and securing the components of near-eye displays 20 on the head or near the eye of a user. Near-eye displays 20 may include one or more display modules such as display modules 20A and one or more optical systems such as optical systems 20B. Display modules 20A may be mounted in a support structure such as support structure 8. Each display module 20A may emit light 38 (image light) that is redirected towards a user's eyes at eye box 24 using an associated one of optical systems 20B.

The operation of system 10 may be controlled using control circuitry 16. Control circuitry 16 may include storage and processing circuitry for controlling the operation of system 10. Circuitry 16 may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 16 may be based on one or more microprocessors, microcontrollers, digital signal processors, baseband processors, power management units, audio chips, graphics processing units, application specific integrated circuits, and other integrated circuits. Software code may be stored on storage in circuitry 16 and run on processing circuitry in circuitry 16 to implement operations for system 10 (e.g., data gathering operations, operations involving the adjustment of components using control signals, image rendering operations to produce image content to be displayed for a user, etc.).

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide head-mounted device 10 with user input. Input-output devices 12 may also be used to gather information on the environment in which system 10 (e.g., head-mounted device 10) is operating. Output components in devices 12 may allow system 10 to provide a user with output and may be used to communicate with external electrical equipment. Input-output devices 12 may include sensors and other components 18 (e.g., image sensors for gathering images of real-world object that are digitally merged with virtual objects on a display in system 10, accelerometers, depth sensors, light sensors, haptic output devices, speakers, batteries, wireless communications circuits for communicating between system 10 and external electronic equipment, etc.).

Display modules 20A may be liquid crystal displays, organic light-emitting diode displays, laser-based displays, or displays of other types. Optical systems 20B may form lenses that allow a viewer (see, e.g., a viewer's eyes at eye box 24) to view images on display(s) 20. There may be two optical systems 20B (e.g., for forming left and right lenses) associated with respective left and right eyes of the user. A single display 20 may produce images for both eyes or a pair of displays 20 may be used to display images. In configurations with multiple displays (e.g., left and right eye displays), the focal length and positions of the lenses formed by system 20B may be selected so that any gap present between the displays will not be visible to a user (e.g., so that the images of the left and right displays overlap or merge seamlessly).

If desired, optical system 20B may contain components (e.g., an optical combiner, etc.) to allow real-world image light from real-world images or objects 28 to be combined optically with virtual (computer-generated) images such as virtual images in image light 38. In this type of system, which is sometimes referred to as an augmented reality system, a user of system 10 may view both real-world content and computer-generated content that is overlaid on top of the real-world content. Camera-based augmented reality systems may also be used in device 10 (e.g., in an arrangement in which a camera captures real-world images of object 28 and this content is digitally merged with virtual content at optical system 20B).

System 10 may, if desired, include wireless circuitry and/or other circuitry to support communications with a computer or other external equipment (e.g., a computer that supplies display 20 with image content). During operation, control circuitry 16 may supply image content to display 20. The content may be remotely received (e.g., from a computer or other content source coupled to system 10) and/or may be generated by control circuitry 16 (e.g., text, other computer-generated content, etc.). The content that is supplied to display 20 by control circuitry 16 may be viewed by a viewer at eye box 24.

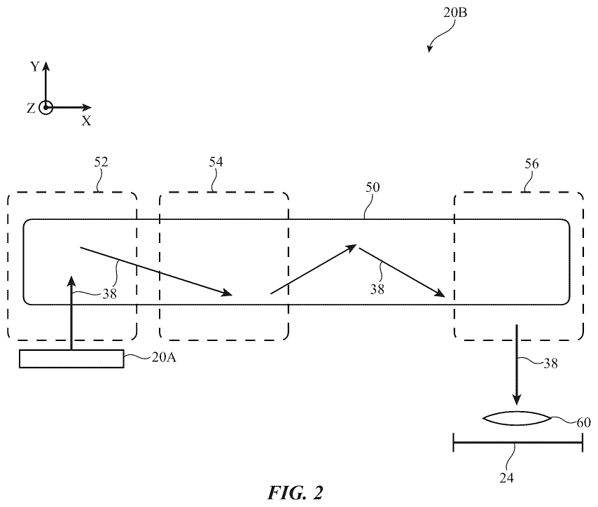

FIG. 2 is a top view of an illustrative display 20 that may be used in system 10 of FIG. 1. As shown in FIG. 2, near-eye display 20 may include one or more display modules such as display module(s) 20A and an optical system such as optical system 20B. Optical system 20B may include optical elements such as one or more waveguides 50. Waveguide 50 may include one or more stacked substrates (e.g., stacked planar and/or curved layers sometimes referred to herein as waveguide substrates) of optically transparent material such as plastic, polymer, glass, etc.

If desired, waveguide 50 may also include one or more layers of holographic recording media (sometimes referred to herein as holographic media, grating media, or diffraction grating media) on which one or more diffractive gratings are recorded (e.g., holographic phase gratings, sometimes referred to herein as holograms). A holographic recording may be stored as an optical interference pattern (e.g., alternating regions of different indices of refraction) within a photosensitive optical material such as the holographic media. The optical interference pattern may create a holographic phase grating that, when illuminated with a given light source, diffracts light to the targeted direction with the designed phase modulation. The holographic phase grating may be a non-switchable diffractive grating that is encoded with a permanent interference pattern or may be a switchable diffractive grating in which the diffracted light can be modulated by controlling an electric field applied to the holographic recording medium. Multiple holographic phase gratings (holograms) may be recorded within (e.g., superimposed within) the same volume of holographic medium if desired. The holographic phase gratings may be, for example, volume holograms or thin-film holograms in the grating medium. The grating media may include photopolymers, gelatin such as dichromated gelatin, silver halides, holographic polymer dispersed liquid crystal, or other suitable holographic media.

Diffractive gratings on waveguide 50 may include holographic phase gratings such as volume holograms or thin-film holograms, meta-gratings, or any other desired diffractive grating structures. The diffractive gratings on waveguide 50 may also include surface relief gratings formed on one or more surfaces of the substrates in waveguides 50, gratings formed from patterns of metal or dielectric structures, etc. The diffractive gratings may, for example, include multiple multiplexed gratings (e.g., holograms) that at least partially overlap within the same volume of grating medium (e.g., for diffracting different colors of light and/or light from a range of different input angles at one or more corresponding output angles). Other light redirecting elements such as louvered mirrors may be used in place of diffractive gratings in waveguide 50 if desired.

As shown in FIG. 2, display module 20A may generate image light 38 associated with image content to be displayed to eye box 24. Image light 38 may be collimated using a collimating lens if desired. Optical system 20B may be used to present image light 38 output from display module 20A to eye box 24. If desired, display module 20A may be mounted within support structure 8 of FIG. 1 while optical system 20B may be mounted between portions of support structure 8 (e.g., to form a lens that aligns with eye box 24). Other mounting arrangements may be used, if desired.

Optical system 20B may include one or more optical couplers (e.g., light redirecting elements) such as input coupler 52, cross-coupler 54, and output coupler 56. In the example of FIG. 2, input coupler 52, cross-coupler 54, and output coupler 56 are formed at or on waveguide 50. Input coupler 52, cross-coupler 54, and/or output coupler 56 may be completely embedded within the substrate layers of waveguide 50, may be partially embedded within the substrate layers of waveguide 50, may be mounted to waveguide 50 (e.g., mounted to an exterior surface of waveguide 50), etc.

Waveguide 50 may guide image light 38 down its length via total internal reflection. Input coupler 52 may be configured to couple image light 38 from display module 20A into waveguide 50, whereas output coupler 56 may be configured to couple image light 38 from within waveguide 50 to the exterior of waveguide 50 and towards eye box 24. Input coupler 52 may include an input coupling prism, an edge or face of waveguide 50, a lens, a steering mirror or liquid crystal steering element, or any other desired input coupling elements. As an example, display module 20A may emit image light 38 in the +Y direction towards optical system 20B. When image light 38 strikes input coupler 52, input coupler 52 may redirect image light 38 so that the light propagates within waveguide 50 via total internal reflection towards output coupler 56 (e.g., in the +X direction within the total internal reflection (TIR) range of waveguide 50). When image light 38 strikes output coupler 56, output coupler 56 may redirect image light 38 out of waveguide 50 towards eye box 24 (e.g., back along the Y-axis). A lens such as lens 60 may help to direct or focus image light 38 onto eye box 24. Lens 60 may be omitted if desired. In scenarios where cross-coupler 54 is formed on waveguide 50, cross-coupler 54 may redirect image light 38 in one or more directions as it propagates down the length of waveguide 50, for example. In redirecting image light 38, cross-coupler 54 may also perform pupil expansion on image light 38.

Input coupler 52, cross-coupler 54, and/or output coupler 56 may be based on reflective and refractive optics or may be based on diffractive (e.g., holographic) optics. In arrangements where couplers 52, 54, and 56 are formed from reflective and refractive optics, couplers 52, 54, and 56 may include one or more reflectors (e.g., an array of micromirrors, partial mirrors, louvered mirrors, or other reflectors). In arrangements where couplers 52, 54, and 56 are based on diffractive optics, couplers 52, 54, and 56 may include diffractive gratings (e.g., volume holograms, surface relief gratings, etc.).

The example of FIG. 2 is merely illustrative. Optical system 20B may include multiple waveguides that are laterally and/or vertically stacked with respect to each other. Each waveguide may include one, two, all, or none of couplers 52, 54, and 56. Waveguide 50 may be at least partially curved or bent if desired. One or more of couplers 52, 54, and 56 may be omitted. If desired, optical system 20B may include an optical coupler such as a surface relief grating structure that performs the operations of both cross-coupler 54 and output coupler 56. For example, the surface relief grating structure may redirect image light 38 as the image propagates down waveguide 50 (e.g., while expanding the image light) and the surface relief grating structure may also couple image light 38 out of waveguide 50 and towards eye box 24.

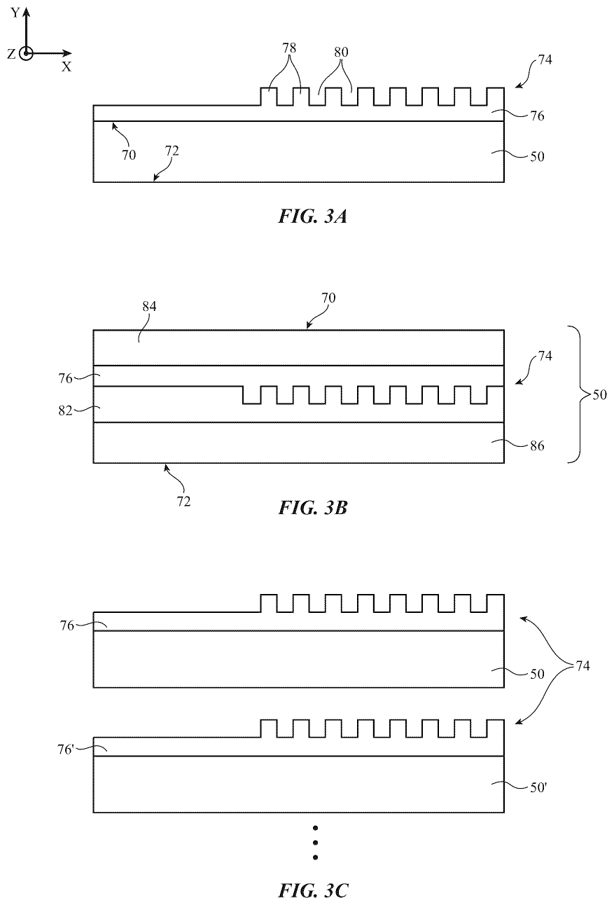

FIG. 3A is a top view showing one example of how a surface relief grating structure may be formed on waveguide 50. As shown in FIG. 3A, waveguide 50 may have a first lateral (e.g., exterior) surface 70 and a second lateral surface 72 opposite lateral surface 70. Waveguide 50 may include any desired number of one or more stacked waveguide substrates. If desired, waveguide 50 may also include a layer of grating medium sandwiched (interposed) between first and second waveguide substrates (e.g., where the first waveguide substrate includes lateral surface 70 and the second waveguide substrate includes lateral surface 72).

Waveguide 50 may be provided with a surface relief grating structure such as surface relief grating structure 74. Surface relief grating (SRG) structure 74 may be formed within a substrate such as a layer of SRG substrate (medium) 76. In the example of FIG. 3A, SRG substrate 76 is layered onto lateral surface 70 of waveguide 50. This is merely illustrative and, if desired, SRG substrate 76 may be layered onto lateral surface 72 (e.g., the surface of waveguide 50 that faces the eye box).

SRG structure 74 may include at least two partially-overlapping surface relief gratings. Each surface relief grating in SRG structure 74 may be defined by corresponding ridges (peaks) 78 and troughs (minima) 80 in the thickness of SRG substrate 76. In the example of FIG. 3A, SRG structure 74 is illustrated for the sake of clarity as a binary structure in which the surface relief gratings in SRG structure 74 are defined either by a first thickness associated with peaks 78 or a second thickness associated with troughs 80. This is merely illustrative. If desired, SRG structure 74 may be non-binary (e.g., may include any desired number of thicknesses following any desired profile, may include peaks 78 that are angled at non-parallel fringe angles with respect to the Y axis, etc.). If desired, SRG substrate 76 may be adhered to lateral surface 70 of waveguide 50 using a layer of adhesive (not shown). SRG structure 74 may be fabricated separately from waveguide 50 and may be adhered to waveguide 50 after fabrication, for example. As another example, ridges 78 may be patterned to substrate 50 without an intervening SRG substrate 76.

The example of FIG. 3A is merely illustrative. In another implementation, SRG structure 74 may be placed at a location within the interior of waveguide 50, as shown in the example of FIG. 3B. As shown in FIG. 3B, waveguide 50 may include a first waveguide substrate 84, a second waveguide substrate 86, and a media layer 82 interposed between waveguide substrate 84 and waveguide substrate 86. Media layer 82 may be a grating or holographic recording medium, a layer of adhesive, a polymer layer, a layer of waveguide substrate, or any other desired layer within waveguide 50. SRG substrate 76 may be layered onto the surface of waveguide substrate 84 that faces waveguide substrate 86. Alternatively, SRG substrate 76 may be layered onto the surface of waveguide substrate 86 that faces waveguide substrate 84.

If desired, SRG structure 74 may be distributed across multiple layers of SRG substrate, as shown in the example of FIG. 3C. As shown in FIG. 3C, the optical system may include multiple stacked waveguides such as at least a first waveguide 50 and a second waveguide 50′. A first SRG substrate 76 may be layered onto one of the lateral surfaces of waveguide 50 whereas a second SRG substrate 76′ is layered onto one of the lateral surfaces of waveguide 50′. First SRG substrate 76 may include one or more of the surface relief gratings in SRG structure 74. Second SRG substrate 76′ may include one or more of the surface relief gratings in SRG structure 74. This example is merely illustrative. If desired, the optical system may include more than two stacked waveguides. In examples where the optical system includes more than two waveguides, each waveguide that is provided with an SRG substrate may include one or more of the surface relief gratings in SRG structure 74. While described herein as separate waveguides, waveguides 50 and 50′ of FIG. 3C may also be formed from respective waveguide substrates of the same waveguide, if desired. The arrangements in FIGS. 3A, 3B, and/or 3C may be combined if desired.

If desired, multiple surface relief gratings may be co-located for redirecting (expanding) image light 38 in different directions (e.g., in an overlapping or interleaved arrangement in or on waveguide 50). The surface relief gratings in SRG structure 74 may overlap in physical space (e.g., when viewed in the −Y direction of FIGS. 3A-3C) and, in implementations where only a single SRG substrate 76 is used, may each at least partially overlap within the same volume of SRG substrate 76. Despite overlapping on waveguide 50, the surface relief gratings in SRG structure 74 may diffract incoming light from and/or onto different respective directions.

The material used to form SRG substrate 76 and/or ridges 78 may be a high refractive index material (e.g., silicon nitride, titanium dioxide, etc.). The high refractive index material may be organic or inorganic. The refractive index of SRG substrate 76 and/or ridges 78 may be greater than 1.5, greater than 1.7, greater than 1.9, greater than 2.0, greater than 2.2, etc. Using a high refractive index material for ridges 78 achieves a strong diffraction effect when immersed in air or another low-index material. However, if care is not taken, specular reflections may be greater than desired. Specular reflections off of the SRG structures may cause glare both on the eye box side of the waveguide (e.g., light travelling in the positive Y-direction may reflect in the negative Y-direction towards the eye box on the negative Y-side of the structure of FIG. 3A) and the non-eye-box side of the waveguide (e.g., light travelling in the negative Y-direction may reflect in the positive Y-direction towards a third person observer of device 10 on the positive Y-side of the structure of FIG. 3A).

To mitigate specular reflections caused by the SRG structure(s) 74, one or more anti-reflective layers may be included in the SRG structures. There are numerous ways for an anti-reflective layer to be incorporated into SRG structure 74. The anti-reflective layer may be incorporated above ridges 78 (such that the ridges are interposed between the anti-reflective layer and the waveguide), below ridges 78 (such that the anti-reflective layer is interposed between the waveguide and the ridges), or both above and below the ridges.

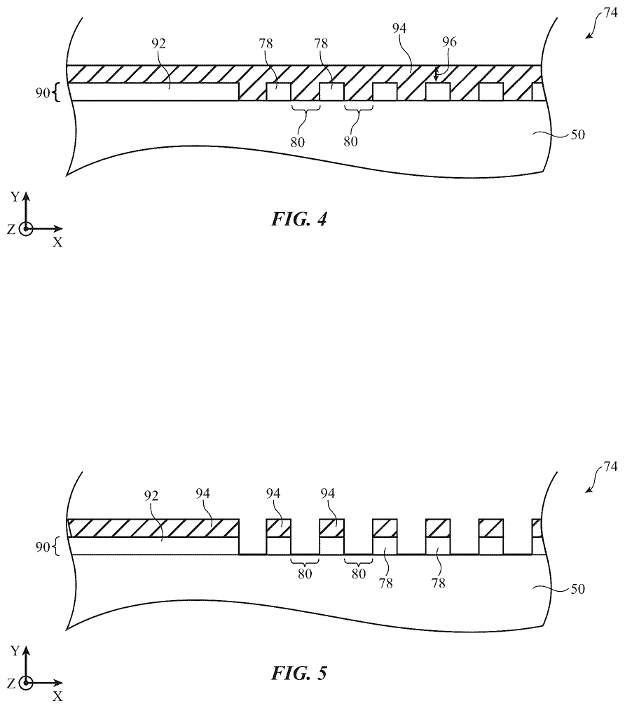

FIG. 4 is a cross-sectional side view of an illustrative SRG structure 74. As shown in FIG. 4, the SRG structure includes a high-index layer 90 that defines ridges 78 on waveguide 50. Additionally, high-index layer 90 forms a non-SRG portion 92 that does not define any ridges. As previously discussed, high-index layer 90 may be formed from an organic or inorganic high refractive index material (e.g., silicon nitride, titanium dioxide, etc.) with a refractive index that is greater than 1.5, greater than 1.7, greater than 1.9, greater than 2.0, greater than 2.2, etc. Troughs 80 are formed between the ridges 78 in the high-index layer 90. In the example of FIG. 4, high-index layer 90 has a thickness of 0 in troughs 80 (e.g., the high-index layer is totally omitted). Alternatively, the high-index layer may have a non-zero thickness in troughs 80 (e.g., as in FIG. 3A).

The magnitude of the height of each ridge may be greater than 50 nanometers, greater than 100 nanometers, greater than 200 nanometers, greater than 300 nanometers, greater than 500 nanometers, greater than 750 nanometers, greater than 1000 nanometers, less than 50 nanometers, less than 100 nanometers, less than 200 nanometers, less than 300 nanometers, less than 500 nanometers, less than 750 nanometers, less than 1000 nanometers, between 200 nanometers and 400 nanometers, between 100 nanometers and 750 nanometers, between 50 nanometers and 1000 nanometers, etc. Each ridge may have a width that is greater than 50 nanometers, greater than 100 nanometers, greater than 200 nanometers, greater than 300 nanometers, greater than 500 nanometers, less than 50 nanometers, less than 100 nanometers, less than 200 nanometers, less than 300 nanometers, less than 500 nanometers, between 50 nanometers and 300 nanometers, between 300 nanometers and 400 nanometers, etc. The center-to-center spacing between the ridges (pitch) may be any desired magnitude (e.g., greater than 50 nanometers, greater than 100 nanometers, greater than 200 nanometers, greater than 300 nanometers, greater than 500 nanometers, greater than 750 nanometers, greater than 1000 nanometers, less than 50 nanometers, less than 100 nanometers, less than 200 nanometers, less than 300 nanometers, less than 500 nanometers, less than 750 nanometers, less than 1000 nanometers, between 200 nanometers and 400 nanometers, between 300 nanometers and 400 nanometers, between 100 nanometers and 750 nanometers, etc.). The duty cycle of the ridges (defined as ridge width divided by ridge pitch) may be greater than 60%, greater than 70%, greater than 80%, greater than 90%, greater than 95%, less than 99%, less than 70%, less than 80%, less than 90%, less than 95%, between 60% and 99%, etc. The ridges may have a uniform spacing or may have a varying spacing. Similarly, the dimensions of each ridge may be uniform or may vary.

As shown in FIG. 4, an anti-reflective layer 94 may be formed over ridges 78 and non-SRG portion 92 of the high-index layer 90. Anti-reflective layer 94 may be formed from a single layer of optical coating (e.g., a single layer of silicon dioxide). In this type of example, the anti-reflective layer 94 has a lower refractive index than the material of layer 90 (and therefore the material of ridges 78). The refractive index of anti-reflective layer 94 may be lower than the refractive index of ridges 78 by at least 0.1, at least 0.3, at least 0.5, at least 0.7, at least 1.0, etc. The refractive index of anti-reflective layer 94 may be less than 2.0, less than 1.8, less than 1.6, less than 1.4, etc.

In another possible arrangement, anti-reflective layer 94 (sometimes referred to as anti-reflective coating 94) may include multiple layers of material (e.g., organic or inorganic dielectric material) with varying refractive indices. For example, the anti-reflective layer may include alternating layers of high refractive index material and low refractive index material (e.g., with a refractive index that is at least 0.1 lower than the high refractive index material, at least 0.3 lower than the high refractive index material, at least 0.5 lower than the high refractive index material, at least 0.7 lower than the high refractive index material, etc.). In general, a multi-layer anti-reflective layer includes at least two layers with different refractive indices. The refractive index of a layer within multi-layer anti-reflective layer 94 may be lower than the refractive index of ridges 78 by at least 0.1, at least 0.3, at least 0.5, at least 0.7, at least 1.0, etc.

In FIG. 4, anti-reflective layer 94 is formed above ridges 78 and fills the troughs 80 between ridges 78. Additionally, anti-reflective layer 94 has a thickness 96 above ridges 78. Thickness 96 may be greater than 50 nanometers, greater than 100 nanometers, greater than 200 nanometers, greater than 300 nanometers, greater than 500 nanometers, greater than 750 nanometers, greater than 1000 nanometers, less than 50 nanometers, less than 100 nanometers, less than 200 nanometers, less than 300 nanometers, less than 500 nanometers, less than 750 nanometers, less than 1000 nanometers, between 200 nanometers and 400 nanometers, between 100 nanometers and 750 nanometers, between 50 nanometers and 1000 nanometers, etc. In FIG. 4, thickness 96 is the same both above ridges 78 and above non-SRG portion 92. This example is merely illustrative and thickness 96 may vary over different subsets of ridges 78, over non-SRG portion 92, etc.

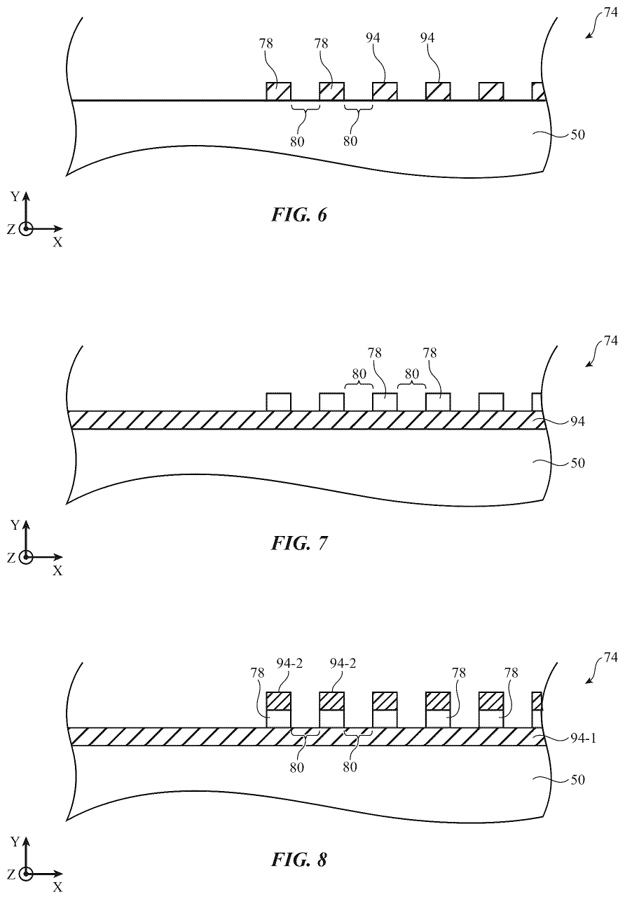

The example in FIG. 4 of anti-reflective layer 94 filling the troughs 80 between adjacent ridges is merely illustrative. In another possible arrangement, shown in FIG. 5, anti-reflective layer 94 is patterned to overlap ridges 78 (and non-SRG portion 92) without overlapping (filling) troughs 80. This type of arrangement may have improved diffraction efficiency compared with FIG. 4 (due to the troughs being filled with air in FIG. 5 instead of layer 94 as in FIG. 4). However, the arrangement of FIG. 4 may have reduced manufacturing cost and complexity compared to the arrangement of FIG. 5. In yet another example, shown in FIG. 6, ridges 78 are formed by the anti-reflective layer 94 itself.

In FIGS. 4 and 5, anti-reflective layer 94 is formed over ridges 78 in SRG structure 74. In this arrangement, ridges 78 are interposed between waveguide 50 and anti-reflective layer 94. This example is merely illustrative. In another possible arrangement, shown in FIG. 7, the anti-reflective layer 94 is formed below ridges 78 in SRG structure 74. In this arrangement, anti-reflective layer 94 is interposed between waveguide 50 and ridges 78. In FIG. 7, anti-reflective layer 94 has a uniform thickness and covers waveguide 50. Ridges 78 are then formed directly on the upper surface of anti-reflective layer 94.

Anti-reflective layers may be formed both above and below ridges 78 if desired. As shown in FIG. 8, a first anti-reflective layer 94-1 is formed below ridges 78 (such that the anti-reflective layer 94-1 is interposed between waveguide 50 and ridges 78). A second anti-reflective layer 94-2 is formed above ridges 78 (such that the ridges 78 are interposed between waveguide 50 and anti-reflective layer 94-2).

In FIG. 8, anti-reflective layer 94-2 is patterned to overlap ridges 78 without overlapping (filling) troughs 80 (as in FIG. 5, for example). This example is merely illustrative. In another possible arrangement, shown in FIG. 9, anti-reflective layer 94-2 may fill the troughs 80 between ridges 78 (similar to as in FIG. 4).

When multiple anti-reflective layers are included in the SRG structure (as in FIGS. 8 and 9, for example), each anti-reflective layer may either be a single-layer anti-reflection layer (e.g., a single layer of optical coating with a refractive index lower than the refractive index of the high-index layer 90) or a multi-layer anti-reflection layer (as described above). Anti-reflective layer 94-1 may be a single-layer anti-reflective layer while anti-reflective layer 94-2 may be a multi-layer anti-reflective layer, or vice versa.

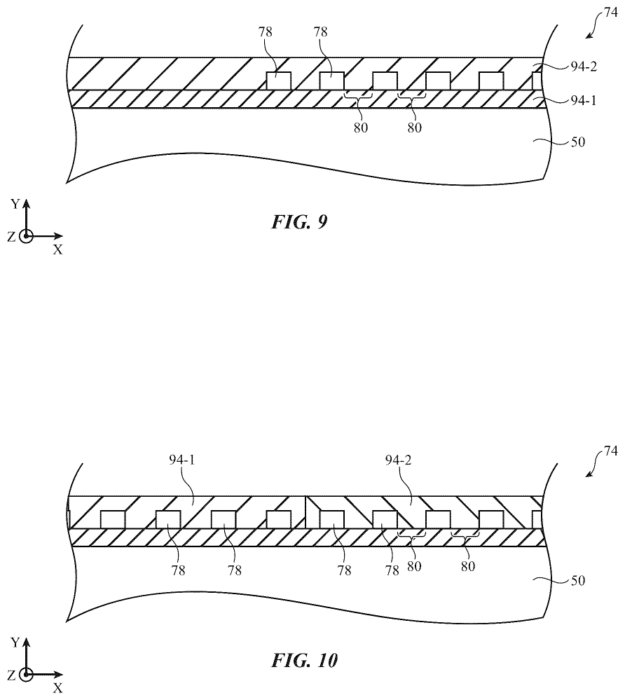

In another possible arrangement, shown in FIG. 10, different ridges may be covered by different anti-reflective layers. For example, a first subset of ridges 78 in FIG. 10 are covered by anti-reflective layer 94-1 while a second subset of ridges 78 in FIG. 10 are covered by anti-reflective layer 94-2. Anti-reflective layers 94-1 and 94-2 may have at least one differing property (e.g., material, dimension, number of layers, etc.). Anti-reflective layer 94-1 may be a single-layer anti-reflective layer while anti-reflective layer 94-2 may be a multi-layer anti-reflective layer, or vice versa. Anti-reflective layers 94-1 and 94-2 may be multi-layer anti-reflective layers with differing layer stack-ups.

Including different anti-reflective layers over different subsets of ridges as in FIG. 10 is merely illustrative. If desired, an anti-reflective layer that is formed below ridges (e.g., as in FIGS. 7-9) may be split into two anti-reflective layers with at least one differing property (with each anti-reflective layer below a respective subset of the ridges). Additionally, different subsets of ridges may be aligned with anti-reflective coatings in different locations if desired. For example, a first subset of ridges may be positioned below a first anti-reflective coating (as in FIG. 4 or FIG. 5) while a second subset of ridges may be positioned above a second anti-reflective coating (a in FIG. 7)

FIG. 11 shows another possible arrangement for an anti-reflective layer in surface relief grating structure 74. In FIG. 11, an anti-reflective layer 94 is formed as a conformal coating over ridges 78. In other words, the thickness of anti-reflective layer 94 in FIG. 11 is the same above ridges 78 as between ridges 78 in troughs 80 (e.g., anti-reflective layer 94 has a uniform thickness). Across the surface relief grating structure, the thickness of anti-reflective layer 94 may be uniform within 10%, within 5%, etc.

FIG. 11 shows how an encapsulation layer 98 may be formed over ridges 78 with conformal anti-reflective layer 94. Encapsulation layer 98 may be formed from the same material as ridges 78 or from a different material than ridges 78. Encapsulation layer 98 has a planar upper surface. Encapsulation layer 98 has a greater thickness over troughs 80 than over ridges 78.

In the example of FIG. 11, the anti-reflective layer 94 has a lower refractive index than the material of ridges 78. The refractive index of anti-reflective layer 94 may be lower than the refractive index of ridges 78 by at least 0.1, at least 0.3, at least 0.5, at least 0.7, at least 1.0, etc. The refractive index of anti-reflective layer 94 may be less than 2.0, less than 1.8, less than 1.6, less than 1.4, etc.

In another possible arrangement, anti-reflective layer 94 (sometimes referred to as anti-reflective coating 94) may include multiple layers of material (e.g., organic or inorganic dielectric material). Multiple coatings may collectively be referred to as a single anti-reflective layer 94. As one example, anti-reflective layer 94 may include multiple layers of material with varying refractive indices. For example, the anti-reflective layer may include alternating layers of high refractive index material and low refractive index material. The refractive index of a layer within multi-layer anti-reflective layer 94 may be lower than the refractive index of ridges 78 by at least 0.1, at least 0.3, at least 0.5, at least 0.7, at least 1.0, etc.

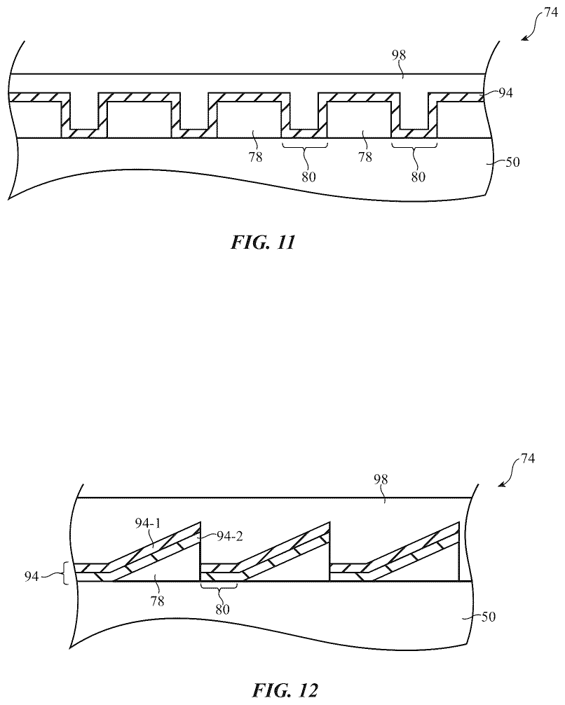

Each coating in anti-reflective layer 94 may be conformally coated or directionally coated on the underlying ridges 78. FIG. 12 is a cross-sectional sideview of an illustrative surface relief grating structure with ridges 78 having angled surfaces. FIG. 12 shows an example where the anti-reflective layer 94 is formed using first and second coatings 94-1 and 94-2 that are deposited using a directional coating technique.

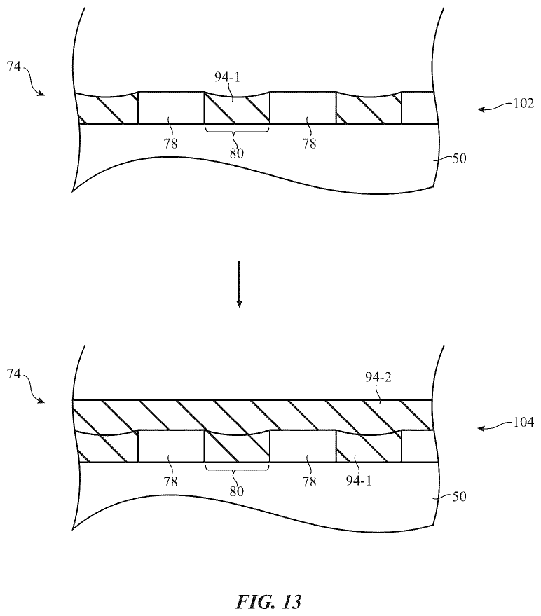

When an encapsulation layer is formed over ridges 78, the encapsulation layer may be formed using two deposition steps to improve the flatness of the upper surface of the encapsulation layer. FIG. 13 shows a two-step method of forming an encapsulation layer over ridges in a surface relief grating structure.

At step 102, a first layer 94-1 is formed in troughs 80 between ridges 78. In a subsequent deposition step 104, a second layer 94-2 is formed over the ridges 78 and first layer 94-1. The upper surface of the second layer 94-2 is planar. Each one of layers 94-1 and 94-2 may be spin coating resins.

In FIG. 13, an example is shown where the two-part deposition process is applied to anti-reflective layer 94. This example is merely illustrative. In general, the two-part deposition process of FIG. 13 may be applied to any desired layer with a planar upper surface (e.g., encapsulation layer 98 in FIGS. 11 and 12, layer 94 in in FIG. 4, layer 94-2 in FIG. 9, layers 94-1 and 94-2 in FIG. 10, etc.).

If desired, a surface relief grating may be encapsulated by a metal material. In other words, encapsulation layer 98 in FIG. 11 and/or FIG. 12 may be formed from metal.

All of the layers described herein (e.g., the substrate, ridges, anti-reflective layer(s), etc.) can form complex near-field effects with incident light propagating in total internal reflection (TIR). The layer thicknesses must be co-designed for a given grating. Including extra layers allows for more free parameters. The overall device end-to-end image color uniformity can be improved by optimizing these thickness combinations.

Optical system 20B may include one or more optical couplers (e.g., an input coupler, a cross-coupler, and an output coupler) formed at or on a waveguide. As examples, the optical system may have a sequential architecture or a combined architecture.

In a sequential architecture, image light may be directed to an input coupler, a cross coupler, and an output coupler in that order. As a specific example, a cross coupler may be at least partially laterally interposed between an input coupler (e.g., an input prism) and an output coupler. The input coupler may be laterally interposed between the cross coupler and an edge of the waveguide. The input prism may couple light into the waveguide. A cross coupler may expand the in-coupled light in a first direction and may provide the light to the output coupler. The output coupler may expand the light in a second direction that is different than the first direction.

In a combined architecture, image light may be directed from an input coupler to a combined optical coupler that performs the function of both a cross coupler and an output coupler. It may be desirable for the output coupler on the waveguide to fill as large of an eye box with as uniform-intensity image light as possible. The combined optical coupler may perform the functionality of both a cross-coupler and an output coupler for the waveguide. The combined optical coupler may therefore be configured to expand image light in one or more dimensions while also coupling the image light out of the waveguide. By using a combined optical coupler in this manner, space may be conserved within the display.

Any of the SRG structures described herein may be used to form any optical coupler (e.g., an input coupler, a cross coupler, an output coupler, a combined optical coupler that performs the function of both a cross coupler and an output coupler, etc.) in optical systems with either a sequential architecture or a combined architecture. When SRG structures form multiple optical couplers, a single SRG structure may be described has having ridges, a first subset of which form a first optical coupler and a second subset of which form a second optical coupler. Alternatively, a first SRG structure may be described as defining a first optical coupler while a second SRG structure may be described as defining a second optical coupler.

Different optical couplers may have different anti-reflective layer arrangements. For example, a first optical coupler (e.g., an input coupler) may have ridges and an anti-reflective layer formed above the ridges while a second optical coupler (e.g., a combined optical coupler that performs the function of both a cross coupler and an output coupler) may have ridges and an anti-reflective layer formed below the ridges. As another example, a first optical coupler (e.g., an input coupler) may have ridges and an anti-reflective layer formed above and between the ridges (as in FIG. 4) while a second optical coupler (e.g., a combined optical coupler that performs the function of both a cross coupler and an output coupler) may have ridges and an anti-reflective layer patterned to overlap ridges but not fill troughs between the ridges (as in FIG. 5). As yet another example, a first optical coupler (e.g., an input coupler) may have ridges and a single-layer anti-reflective layer that overlaps the ridges while a second optical coupler (e.g., a combined optical coupler that performs the function of both a cross coupler and an output coupler) may have ridges and a multi-layer anti-reflective layer that overlaps the ridges.

In general, any of the anti-reflective layers described herein in connection with FIGS. 4-13 may be a single-layer anti-reflective layer or a multi-layer anti-reflective layer.

In accordance with an embodiment, a display system is provided that includes a waveguide configured to propagate image light and a surface relief grating structure at the waveguide, the surface relief grating structure includes a plurality of ridges separated by a plurality of troughs and an anti-reflective layer formed over the plurality of ridges, the anti-reflective layer fills the plurality of troughs and the plurality of ridges is interposed between the waveguide and the anti-reflective layer.

In accordance with another embodiment, the anti-reflective layer includes a plurality of layers with different refractive indices.

In accordance with another embodiment, the surface relief grating structure further includes an additional anti-reflective layer that is interposed between the plurality of ridges and the waveguide.

In accordance with another embodiment, the anti-reflective layer is a single layer of optical coating.

In accordance with another embodiment, the plurality of ridges is formed from a material with a first refractive index, the anti-reflective layer includes a material with a second refractive index, and the second refractive index is lower than the first refractive index by at least 0.3.

In accordance with another embodiment, the anti-reflective layer is a first anti-reflective layer, the plurality of ridges is a first plurality of ridges, the plurality of troughs is a first plurality of troughs, and the surface relief grating structure further includes a second plurality of ridges separated by a second plurality of troughs and a second anti-reflective layer formed over the second plurality of ridges, the second plurality of ridges is interposed between the waveguide and the second anti-reflective layer.

In accordance with another embodiment, the first anti-reflective layer has at least one property that is different than in the second anti-reflective layer.

In accordance with another embodiment, the first plurality of ridges defines an input coupler and the second plurality of ridges defines a combined optical coupler that performs the function of both a cross coupler and an output coupler.

In accordance with another embodiment, the first anti-reflective layer is a single-layer anti-reflective layer and the second anti-reflective layer is a multi-layer anti-reflective layer.

In accordance with another embodiment, the anti-reflective layer has a uniform thickness over both the plurality of ridges and the plurality of troughs.

In accordance with another embodiment, the surface relief grating structure further includes an encapsulation layer that is formed over the anti-reflective layer, the encapsulation layer has a planar surface, a first thickness over the plurality of ridges, and a second thickness that is greater than the first thickness over the plurality of troughs.

In accordance with another embodiment, the encapsulation layer is formed from a same material as the plurality of ridges.

In accordance with an embodiment, a display system is provided that includes a waveguide configured to propagate image light and a surface relief grating structure at the waveguide, the surface relief grating structure includes a plurality of ridges separated by a plurality of troughs and an anti-reflective layer formed between the waveguide and the plurality of ridges.

In accordance with another embodiment, the anti-reflective layer includes a plurality of layers with different refractive indices.

In accordance with another embodiment, the surface relief grating structure further includes an additional anti-reflective layer that is formed over the plurality of ridges and the plurality of ridges is interposed between the additional anti-reflective layer and the anti-reflective layer.

In accordance with another embodiment, the additional anti-reflective layer is patterned to overlap the plurality of ridges without filling the plurality of troughs.

In accordance with another embodiment, the additional anti-reflective layer overlaps the plurality of ridges and fills the plurality of troughs.

In accordance with another embodiment, the anti-reflective layer is a single layer of optical coating.

In accordance with another embodiment, the plurality of ridges is formed from a material with a first refractive index, the anti-reflective layer includes a material with a second refractive index, and the second refractive index is lower than the first refractive index by at least 0.3.

In accordance with an embodiment, a display system is provided that includes a waveguide configured to propagate image light, the waveguide has first and second opposing sides and at least one surface relief grating structure at the waveguide, the at least one surface relief grating structure includes a plurality of ridges separated by a plurality of troughs, the plurality of ridges is formed on the first side of the waveguide, a first anti-reflective layer formed on the first side of the waveguide and aligned with a first subset of the plurality of ridges and a second anti-reflective layer formed on the first side of the waveguide and aligned with a second subset of the plurality of ridges, the first anti-reflective layer has at least one property that is different than in the second anti-reflective layer.

In accordance with another embodiment, the at least one property is a dimension.

In accordance with another embodiment, the at least one property is a material.

In accordance with another embodiment, the at least one property is a number of layers.

The foregoing is merely illustrative and various modifications can be made to the described embodiments. The foregoing embodiments may be implemented individually or in any combination.

What is claimed is:

1. A display system comprising:
a waveguide configured to propagate image light; and
a surface relief grating structure at the waveguide, wherein the surface relief grating structure comprises:
a plurality of ridges separated by a plurality of troughs; and
an anti-reflective layer formed over the plurality of ridges, wherein the anti-reflective layer fills the plurality of troughs and wherein the plurality of ridges is interposed between the waveguide and the anti-reflective layer.

2. The display system defined in claim 1, wherein the anti-reflective layer comprises a plurality of layers with different refractive indices.

3. The display system defined in claim 1, wherein the surface relief grating structure further comprises an additional anti-reflective layer that is interposed between the plurality of ridges and the waveguide.

4. The display system defined in claim 1, wherein the anti-reflective layer is a single layer of optical coating.

5. The display system defined in claim 1, wherein the plurality of ridges is formed from a material with a first refractive index, wherein the anti-reflective layer comprises a material with a second refractive index, and wherein the second refractive index is lower than the first refractive index by at least 0.3.

6. The display system defined in claim 1, wherein the anti-reflective layer is a first anti-reflective layer, wherein the plurality of ridges is a first plurality of ridges, wherein the plurality of troughs is a first plurality of troughs, and wherein the surface relief grating structure further comprises:
a second plurality of ridges separated by a second plurality of troughs; and
a second anti-reflective layer formed over the second plurality of ridges, wherein the second plurality of ridges is interposed between the waveguide and the second anti-reflective layer.

7. The display system defined in claim 6, wherein the first anti-reflective layer has at least one property that is different than in the second anti-reflective layer.

8. The display system defined in claim 7, wherein the first plurality of ridges defines an input coupler and wherein the second plurality of ridges defines a combined optical coupler that performs the function of both a cross coupler and an output coupler.

9. The display system defined in claim 6, wherein the first anti-reflective layer is a single-layer anti-reflective layer and the second anti-reflective layer is a multi-layer anti-reflective layer.

10. The display system defined in claim 1, wherein the anti-reflective layer has a uniform thickness over both the plurality of ridges and the plurality of troughs.

11. The display system defined in claim 10, wherein the surface relief grating structure further comprises:
an encapsulation layer that is formed over the anti-reflective layer, wherein the encapsulation layer has a planar surface, a first thickness over the plurality of ridges, and a second thickness that is greater than the first thickness over the plurality of troughs.

12. The display system defined in claim 11, wherein the encapsulation layer is formed from a same material as the plurality of ridges.

13. A display system comprising:
a waveguide configured to propagate image light; and
a surface relief grating structure at the waveguide, wherein the surface relief grating structure comprises:
a plurality of ridges separated by a plurality of troughs; and
an anti-reflective layer formed between the waveguide and the plurality of ridges.

14. The display system defined in claim 13, wherein the anti-reflective layer comprises a plurality of layers with different refractive indices.

15. The display system defined in claim 13, wherein the surface relief grating structure further comprises an additional anti-reflective layer that is formed over the plurality of ridges and wherein the plurality of ridges is interposed between the additional anti-reflective layer and the anti-reflective layer.

16. The display system defined in claim 15, wherein the additional anti-reflective layer is patterned to overlap the plurality of ridges without filling the plurality of troughs.

17. The display system defined in claim 15, wherein the additional anti-reflective layer overlaps the plurality of ridges and fills the plurality of troughs.

18. The display system defined in claim 13, wherein the anti-reflective layer is a single layer of optical coating.

19. The display system defined in claim 13, wherein the plurality of ridges is formed from a material with a first refractive index, wherein the anti-reflective layer comprises a material with a second refractive index, and wherein the second refractive index is lower than the first refractive index by at least 0.3.

20. A display system comprising:
a waveguide configured to propagate image light, wherein the waveguide has first and second opposing sides; and
at least one surface relief grating structure at the waveguide, wherein the at least one surface relief grating structure comprises:
a plurality of ridges separated by a plurality of troughs, wherein the plurality of ridges is formed on the first side of the waveguide;
a first anti-reflective layer formed on the first side of the waveguide and aligned with a first subset of the plurality of ridges; and.
a second anti-reflective layer formed on the first side of the waveguide and aligned with a second subset of the plurality of ridges, wherein the first anti-reflective layer has at least one property that is different than in the second anti-reflective layer.

21. The display system defined in claim 20, wherein the at least one property is a dimension.

22. The display system defined in claim 20, wherein the at least one property is a material.

23. The display system defined in claim 20, wherein the at least one property is a number of layers.
